(19) United States
(12) Patent Application Publication
(10) Pub. No.: US 2024/0044008 A1
(43) Pub. Date: Feb. 8, 2024

(54) Method for Coating Nuclear Power Plant Components

(71) Applicants: Robert D. Varrin, JR., Reston, VA (US); Isaiah O. Oladeji, Gotha, FL (US)

(72) Inventors: Robert D. Varrin, JR., Reston, VA (US); Isaiah O. Oladeji, Gotha, FL (US)

(21) Appl. No.: 18/201,418

(22) Filed: May 24, 2023

Related U.S. Application Data
(60) Provisional application No. 63/395,197, filed on Aug. 4, 2022.

(51) Int. Cl. C23C 18/42; G21C 21/00; C23C 18/16; C23C 18/18

(52) U.S. Cl. CPC C23C 18/42; G21C 21/00; C23C 18/1637; C23C 18/1676; C23C 18/18

(57) ABSTRACT

A method for depositing divalent metal compounds on the surface of a nuclear power plant component, the component being a nickel-based or austenitic stainless steel alloy includes: providing within the component an aqueous treatment solution containing at least one soluble metal-containing compound such as a zinc salt and at least one source of oxygen; allowing the treatment solution to remain in the component until the compound is deposited on the wetted surface of the component; and, removing the aqueous solution after exposure. The treatment may be applied more than once, using more than one divalent metal compound, and the surface may further be exposed to a solution containing a noble metal species and a reducing agent. The treatment temperature is preferably below 100° C.

### CROSS REFERENCE TO RELATED APPLICATION

This application claims the benefit of U.S. Provisional Patent Application No. 63/395,197 entitled, “Method for Coating Nuclear Power Plant Components,” filed by the present inventors on Aug. 4, 2022, the entire disclosure of which is incorporated herein by reference.

### BACKGROUND OF THE INVENTION

### Field of the Invention

The invention pertains to methods for making protective coatings on stainless steel and nickel alloys, and more particularly to methods for depositing zinc compounds with or without noble metals on the wetted surfaces of nuclear power plant components.

### Description of Related Art

Nuclear power plants that use water (H₂O) as the primary coolant and heat transfer medium include pressurized water reactors (PWRs) and boiling water reactors (BWRs). In both plant designs, the primary coolant is recirculated or pumped at elevated pressure and high temperature through the reactor core through what is known as the primary system. Also known as the reactor coolant system or RCS, the primary system consists of the reactor vessel, pumps, heat exchangers, including steam generators in PWRs, interconnecting piping and other components such as valves. Recirculation may also be achieved by natural circulation without pumps. Most of the RCS components are fabricated from wrought austenitic stainless steel such as Type 316 and Type 304, or nickel-based alloys such as Alloy 600 or Alloy 690, analogous weld metals (e.g., Type 309, Alloy 182, Alloy 82, Alloy 152, and Alloy 52), or cast stainless steel materials (e.g., CF3, CF3M, CF8, and CF8M). Stainless steels used are typically low carbon versions such as 316L and 308L. In some cases, the components are fabricated from carbon and low alloy steels that have been clad or weld metal overlaid with stainless steel or nickel alloys. In this case, the wetted surface is the stainless steel or a nickel alloy overlay. PWR plants typically operate with a reactor coolant temperature of about 300° C. BWR plants typically operate at a temperature of about 260 to 275° C. In the context of this invention normal reactor operating temperature or ROT, is considered “high temperature”. Both PWRs and BWRs may be brought “off line” for maintenance or refueling where the temperature drops and is maintained at less than 100° C. and generally below 40° C. In the context of this invention, temperatures below 100° C. are considered “low temperature”.

Both stainless steels and nickel alloy components in contact with primary coolant are generally resistant to significant corrosion or erosion over the plant lifetime. However, when initially bare metallic surfaces are exposed to the coolant, a thin oxide layer or passive film, a spinel type metal oxide, will form on the component at the metal-coolant interface owing to reactions of the metal with water or small amounts of oxygen or other oxidants in the coolant. These passive films are generally considered protective as they act as a barrier to further corrosion. Nonetheless, while the components exhibit excellent general corrosion resistance in the aqueous reactor coolant at high temperature, especially after formation of the passive film, they are susceptible to some degree of corrosion resulting in material loss. In some situations, the RCS components are also susceptible to intergranular stress corrosion cracking (IGSCC) and irradiation assisted stress corrosion cracking (IASCC). In PWRs, intergranular corrosion is known as primary water stress corrosion cracking (PWSCC). The susceptibility to these types of corrosion depends on several factors including material susceptibility, residual stress and water chemistry including the electrochemical potential (ECP) of the coolant. ECP increases with higher oxygen concentration, especially in BWRs.

Oxidants that contribute to initial formation of passive films and subsequent corrosion include the coolant water itself, trace amounts of oxygen present in makeup water that is added to the RCS to compensate for losses, or species formed by radiolysis of water in the core such as hydrogen peroxide or hydroxyl species. To minimize corrosion at PWRs, oxygen is typically controlled to less than 10 ppb by adding or injecting hydrogen into the coolant. Oxygen can be typically maintained at BWRs at less than 1 to 2 ppb by injection of hydrogen. Anion impurities such as chlorides and sulfates also can exacerbate corrosion.

The structure of the passive films can also be layered. For example, a BWR passive film may consist of a Cr-enriched inner layer and an Fe-based (ferrite) outer layer. The films may also exhibit a normal (or regular) spinel or inverse spinel crystalline structure. In normal spinels, divalent X²⁺ ions occupy tetrahedral sites and trivalent X³⁺ ions occupy octahedral sites. In BWR films, examples of normal spinels would be NiCr₂O₄, FeCr₂O₄, ZnCr₂O₄ and CoCr₂O₄. Inverse spinels include Fe₃O₄ with X²⁺ ions and half of the X³⁺ ions at octahedral sites and half the X³⁺ ions at tetrahedral sites.

PWRs also exhibit distinct layered crystalline structures sometimes consisting of a chromium depleted layer directly adjacent to the metal, an intermediate Ni—Fe—Cr oxide layer, and a nickel ferrite layer in contact with the coolant.

In addition to metal ions in the passive films that form from the underlying base metal, the passive films may incorporate ions from the coolant in contact with or wetting the surface. These ions exist due to a small amount of general corrosion of RCS component base metal or breakdown or dissolution passive films on RCS components.

The primary coolant water chemistry is carefully controlled at plants to minimize corrosion of wetted components. At a PWR, chemicals added to the primary coolant include lithium to elevate pH as a countermeasure to the use of boron as boric acid which lowers pH which increases corrosion rates and can have adverse effects on the integrity of fuel, but is nonetheless required to control nuclear core power by absorbing neutrons. Additives at BWRs may include hydrogen to maintain chemically reducing conditions which reduces the onset or propagation of IGSCC of austenitic steel pressure boundary components (e.g., piping) and reactor internal structures.

Despite careful chemistry control, corrosion and passive film breakdown results in the release of ionic species from the surface of the component into the RCS. In the case of stainless steel, those elements that may be released can include iron (Fe), nickel (Ni) molybdenum (Mo), and manganese (Mn). Other species that can be found in reactor coolant include zirconium (Zr) released from the nuclear fuel cladding and cobalt (Co). Co is found in some components such as valve seats and reactor internals that are fabricated in part from cobalt alloys such as Stellite™ which contains about 50-60% cobalt by weight. Stainless steel can contain up to 0.2% cobalt, which can be released into the RCS by corrosion processes. Significant nickel can be released from nickel alloy PWR steam generator (SG) tubes which exhibit very high surface area, such that even small amounts of release can equate to significant introduction of nickel in the coolant. This is especially true when the SG tubes are new at new plants or when SGs have been replaced at operating plants. This is because a passive protective layer takes time to form during reactor operations at high temperature.

As discussed later, divalent Zn²⁺ may also be intentionally added to the coolant. Noble metals such as platinum (Pt⁴⁺) or palladium (Pd²⁺) may also be added for reasons described later. Rhodium and iridium as also noble metals that can be added.

For normal spinels, divalent ions in the coolant such as Fe²⁺, Co²⁺ or Zn²⁺ can diffuse into the existing passive film replacing the existing ions at the tetrahedral sites by an ion exchange process. For instance, Zn²⁺ has a very high affinity for tetrahedral sites, higher than Fe²⁺, or Co²⁺ and as such can displace these species. Mn²⁺ also has an affinity for tetrahedral sites but not as great as Zn²⁺.

Ions in the coolant may also continue to circulate through the primary system or oxidize in the aqueous coolant phase to form partially soluble solid oxides or combine to form single species metallic oxides or mixed oxides. An example of a solid particulate mixed oxide at a PWR would be nickel ferrite (NiFe₂O₄) with a normal spinel crystal structure. An example metallic oxide would be hematite (Fe₂O₃) in a BWR. Some of the circulating ions and crystalline solid oxides are removed by purification systems used to continuously clean the primary coolant but these are not completely effective in eliminating all impurities, ions or oxides.

In some literature, the term CRUD is also used to define both the passive film that forms on the surface due to exposure to water and oxidized corrosion product species and the materials that deposit on the surface typically on top of the passive films. Herein, the term passive films will be used to describe the thin layer that forms at the surface by oxidation of the underlying metal surface, while CRUD will used to define the material that deposits on top of the passive film or bare metal surfaces. CRUD is typically less dense and less adherent than the passive film.

The thickness of the passive films is generally on the order of 1 to 3 μm. The thickness of the CRUD deposits can be less than 1 micron or up to several millimeters thick. In terms of “specific” surface coverage, a 2 μm thick passive film with 40% porosity and solid oxide density of 5.4 g/cm³ corresponds to a porous film surface coverage of about 600 μg/cm². Some passive films may be thinner, with a surface coverage on the order of 50 μg/cm². BWR CRUD films can be quite thick, with surface coverage up to 10,000 μg/cm².

Once in the fluid phase of the RCS, solid oxides and ions may precipitate or deposit in the form of “corrosion products” on surfaces including on the wetted surfaces of pipes, valves and other components. As mentioned earlier, these deposits are sometimes known in the industry as CRUD. In PWRs the most common chemical oxide of CRUD is nickel ferrite represented often with the chemical formula NiFe₂O₄, but the Ni/Fe ratio can be lower than 1:2. In BWRs, a principal CRUD constituents can be hematite (Fe₂O₃), magnetite (Fe₃O₄) or chromium oxides. Other nickel oxides can be part of the CRUD deposits on fuel surfaces. Metals can also be found at surfaces, such as nickel metal on fuel.

A key goal of owners and operators of nuclear power plants is minimizing worker dose due to exposure to ionizing radiation. In this regard, the role of cobalt in the RCS is worth noting. Cobalt (Co) ions, Co oxides or Co metal in the coolant is initially in the form of the naturally occurring stable isotope Co⁵⁹ but can become activated by neutron capture in the core to form Co⁶⁰. Co⁶⁰ emits gamma radiation with a half-life of 5.27 years, and is a major source of radiation at plants and consequent worker exposure if this cobalt becomes incorporated into passive films or becomes a component in CRUD. The cobalt concentration on BWR coolant is on the order of 0.1 ppb. The concentration of Co in passive films or CRUD can be from 0.1 to 2% in BWR passive layers. For an exemplary passive film surface coverage of 600 μg/cm², this would correspond to about 0.6 to 12 μg/cm² of cobalt mass per unit surface area.

Occupational radiation exposure can occur during routine plant operations, during plant outages for maintenance or refueling, and during plant decommissioning. The major contributor to worker dose is Co⁶⁰ incorporated into corrosion product films on plant components such as piping.

Based on the above summary, those skilled in the art will recognize that it is advantageous to reduce formation of CRUD, remove CRUD by chemical or mechanical cleaning or chemical “decontamination”, maintain a low ECP to avoid for example IGSCC at BWRs, and promote formation of passive films that provide corrosion protection but limit accumulation of Co⁶⁰. Each of these topics is discussed below.

### Strategies to Reduce CRUD Buildup

Reducing the formation of CRUD can be accomplished with strict control of the primary coolant chemistry. It can also be achieved by using corrosion resistant materials during fabrication of components such as methods described in U.S. Pat. No. 11,136,660 which involves incorporating zinc, chromium or iron as metal or oxide in the material at a surface before the material is formed into the parts such as steam generators tubing made with nickel-based alloy. As discussed later, the addition of zinc to the RCS has also been shown to reduce corrosion rates of stainless steel, a source of precursors to CRUD formation.

Decontamination to Remove CRUD and Passive Films to Reduce Accumulated Co⁶⁰

Removing CRUD and passive films can be achieved by a variety of chemical decontamination processes that use reducing or oxidizing solutions alone or in series to dissolve the CRUD and passive films. These decontaminations are performed with the plant off-line during periods of maintenance or refueling. The entire RCS may be targeted for cleaning or isolatable sections of the RCS may be targeted such as the reactor recirculation loops at BWRs. Isolation of portions of systems can be done by closing plant valves or installing temporary plugs in piping or components. Application temperature range from room temperature (˜25° C.) up to 100° C. or even up to 120° C. The solutions often include chelating or complexing agents such as oxalic acid, nitric acid, citric acid, ethylenediamine tetra acetic acid (EDTA), and either oxidant or reducing agent depending on whether metals or oxides are being targeted for removal. CRUD can also be removed mechanically by using high pressure water jets or ultrasonics. In most cases, neither chemical nor mechanical decontamination is 100% effective so the resulting surface may exhibit areas with residual passive films or CRUD deposits, plus areas of bare decontaminated metal.

### Achieving a Favorable ECP

Maintaining ECP at low levels can be achieved by adding noble metals to the reactor coolant at BWRs including metals such as such as platinum, rhodium, iridium or palladium. “Low levels” of ECP are defined in proprietary industry water chemistry guidelines but also in the open literature. A typical goal is −230 mV vs SHE (or standard hydrogen electrode, a potential that is a reference potential as compared to the potential at the wetted surfaces or in the bulk fluid). At a typical oxygen concentration of 0.4 ppm in the coolant, the ECP can be >0 mV vs SHE which without noble metals can lead to IGSCC. Noble metal chemical application (NMCA) includes NobleChem™ which was developed by the Electric Power Research Institute and General Electric. One chemical used for platinum addition is sodium hexaplatinate or Na₂Pt(OH)₆ added over a few days or weeks. The noble metal adsorbs as the metal on surfaces including on passive films or bare metal (such as after a chemical decontamination or new components). The noble metal catalyzes the reaction of hydrogen added to the coolant with oxygen or hydrogen peroxide generated by radiolysis of water in the core to reduce the oxidant concentration in the coolant. NMCA can be performed online at normal operating temperature or while the plant is shutting down for an outage at around 110 to 149° C. (General Electric's On Line Nobel Chem or OLNC). Target depositions are in the range of 0.5 to 1 μg/cm² corresponding less than 1% of the passive layer specific surface loading on stainless steel components, but no more than the equivalent of 30 μg/cm² total cumulative metal addition to the RCS based on fuel surface area to avoid undesirable deposition on fuel. If applied online, noble metal addition may be limited to starting no sooner than about 90 days after starting up the plant after a refueling outage to prevent early deposition on fresh fuel which can lead to fuel cladding corrosion—the exact duration of this delay is typically proprietary and plant specific.

Noble metals can also be added while the plant is offline using similar noble metal compounds at around 90° C.—so called low temperature noble chem or LTNC. In this case, rather than treating the entire RCS, noble metals are usually added to portions of the RCS such as a BWR recirculation system. Temporary equipment is used to prepare the chemicals and then, heat, inject and drain the solution from the treated portion of the RCS. For platinum, one chemical often used in LTNC is sodium hexaplatinate or Na₂Pt(OH)₆. In online NMCA, the temperature is high enough that the noble metal species adsorb at the component surface and are incorporated at the surface of or to the interior of the passive film layer. For LTNC, the reaction with Na₂Pt(OH)₆ are slow so a reducing agent such as hydrazine can be added to promote what is known as electroless deposition, similar to processes commonly used in the electroplating industry for gold, nickel, copper and silver metal deposition. LTNC typically is performed in about 24 hours. With the addition of hydrazine, the time has been reported to be reduced to about 4 hours. FIG. 1 is an example of a potential-pH or Pourbaix diagram for the aqueous platinum system that shows that along the lower “hydrogen line” (lower dotted line), corresponding to fully reducing conditions that might be achieved with the addition of hydrazine, metallic platinum is the thermodynamically stable-favorable chemical speciation for Pt from pH from 0 to 13.

One of the main applications for LTNC is to deposit a noble metal such as platinum after chemical decontamination of a system which may remove passive films and previously applied noble metal. These passive films will re-establish themselves during the subsequent return to operation, but the normal practice is to wait several months (e.g., 90 days) before adding the noble metal. During this waiting period, the benefits of noble metal will not be realized at these newly cleaned surfaces. It should be noted that no chemical decontamination is 100% effective so that surface may have areas of clean metal, residual passive film (which may have resulted in partial loss of preexisting noble metal) or residual CRUD. LTNC with a reducing agent can lead to deposition on bare metal, as well as the areas with residual passive films and CRUD.

Reducing Incorporation of Cobalt⁶⁰ into CRUD and Passive Films

As described earlier, the divalent ions Zn²⁺ and Co²⁺ both have an affinity for occupying tetrahedral sites in the normal spinel structure of passive films on nuclear components, particularly those on BWR components such as those in the reactor coolant recirculation system. The addition of zinc to the RCS coolant during normal operation of the plant at high temperature is a well-established method for reducing the incorporation of Co⁶⁰ into passive films and CRUD as Zn²⁺ preferentially occupies tetrahedral sites and can actually displace Co²⁺ if it already occupies a site, through an ion exchange process. This is especially beneficial when zinc is incorporated into the passive films on piping external to the reactor vessel and these pipes can become highly radioactive and are located in areas where workers must maintain and service equipment during refueling outages. An example discussed later is the reactor coolant recirculation system at a BWR.

Zinc has also been reported to inhibit release of Co⁶⁰ that exists on cobalt bearing components such as valve seats and from fuel surfaces. At PWRs, it can also inhibit corrosion of stainless steel surfaces leading to thinner passive surface oxide and hence lower concentrations of Co⁶⁰ given the passive film is thinner.

There are two issues associated with addition of zinc to the RCS. One is the risk that adding zinc at either a BWR or PWR leads to the potential for forming tenacious zinc ferrite deposits on fuel if too much zinc is added or if it is added too early in a cycle of operation after refueling, where much of the fuel is new or “fresh” and free of deposits. As such, industry guidelines typically require that a plant wait up to several months after starting up from a refueling outage before zinc can be added. This means that the beneficial effects of adding zinc are not realized during the first few months of power operation at high temperature.

Another issue is that natural zinc consists of several isotopes. About 49% of natural zinc is Zn⁶⁴. Zn⁶⁴ can become activated in the reactor core to Zn⁶⁵ which is a strong gamma radiation emitter, the presence of which in the reactor coolant system can increase occupational radiation exposure to plant workers. Therefore, the zinc added to the coolant is known as “depleted” zinc, where depletion refers to zinc depleted in the isotope Zn⁶⁴ (depleted to less than 1 at. % Zn⁶⁴). Depleted zinc oxide is known as DZO.

Zinc species used as additives include soluble zinc acetate (Zn(CH₃CO₂)₂(H₂O)₂) or solid powder zinc oxide (ZnO) including nanoparticles as described for example U.S. Pat. No. 6,724,854. The range of concentration of zinc addition as zinc addition in a PWR may be from a few parts per billion (ppb) up to about 100 ppb. At PWRs, lower concentrations (˜10 ppb) are used to control radiation fields, while higher concentrations (10 to 100 ppb) mitigate initiation and growth of PWSCC. At BWRs, zinc is maintained at about 5 to 10 ppb to reduce radiation fields. At both PWRs and BWRS, zinc is added during power operations. As discussed earlier, zinc addition is discouraged early in the startup after a refueling outage because of the potential for formation of zinc ferrite on fresh fuel surfaces which at PWRs increases the potential for crud induced localized corrosion or CILC.

The addition of zinc has also been reported to mitigate IGSCC of components, and techniques for adding zinc oxide to the RCS coolant as nanoparticles as the zinc source as a SCC countermeasure have been described in the literature.

Previously described was the deposition of noble metals after a chemical decontamination at low temperature (40 to 100° C.) using a reductive deposition process analogous to electroless deposition used in the plating industry for noble metals, copper, nickel and gold. This allows the noble metal to suppress oxidant concentrations throughout the entire operating cycle rather than having to wait several months to inject it after startup at high temperature.

However, unlike platinum or other noble metals, it is not chemically or thermodynamically possible to deposit zinc as metal from an aqueous solution even under fully reducing conditions, for example by adding hydrazine. FIG. 2 is a Pourbaix diagram for the zinc-water system that shows that the stable speciation under oxidizing (upper dotted line) or reducing (lower dotted line) is ZnO at pH up to about 12, and ZnO₂²⁻ at pH greater than 12. It is well-known to those skilled in the art that deposition of zinc metals is possible simultaneously with chromium (zinc chromate coating technology) or by electroplating using an applied current with the zinc sullied from a solid zinc anode. However, electroplating zinc in a nuclear component would be difficult owing to the need for placing a zinc anode within the system. The design of a zinc anode that would need to have a geometry that resulted in controlled thickness of the plating would present great challenges in a radioactive system with limited access, and electroplated zinc metal also can lead to the undesired potential for hydrogen embrittlement of the nickel-based alloy or stainless-steel part since hydrogen produced at the cathodic surface of the components can be trapped in the electrodeposited layer. Also, it would not be possible to deposit zinc by electroplating on an electrically insulating passive layer or CRUD deposit.

### Other Reported Methods for Suppressing Cobalt Uptake

Other reported means of suppressing radionuclide deposition on reactor components is to deposit ferrite films at <100° C. after chemical decontamination followed by a LTNC application to deposit a noble metal such as platinum. The ferrite film is formed by injection a solution containing Fe²⁺ stored under reducing conditions which is then combined with an oxidant once in the RCS system to deposit Fe³⁺ under oxidizing conditions, probably as a hydroxide. This leads to a magnetite film (Fe₃O₄) upon heating to normal operating temperature. This film is then considered a preemptive protective layer against radioactive Co incorporation by forming an iron rich inner layer adjacent to the component surface upon startup of the plant with minimal Cr³⁺. One specific example is described in U.S. Pat. No. 7,889,828 which claims that a Cr³⁺ depleted inner layer forms, and incorporation of cobalt in the film is reduced.

FIG. 3 summarizes the relative affinity of metal ions for various sites in spinels, with zinc having the strongest affinity for tetrahedral sites, significantly greater than cobalt and slightly greater than Mn²⁺. It does show that Fe³⁺ in magnetite occupies tetrahedral sites as well, but not with as much affinity as Zn²⁺ or Mn²⁺. [See S. G. Holdsworth, Considering Cobalt Incorporation in Oxide Film Under Boiling Water Reactor Conditions, Ph.D. Thesis, Univ. of Manchester, FIG. 8, p. 32, 2018.]

Another approach describes incorporating zinc into the metal before forming the metal into a part or component as disclosed by Riddle et al. in U.S. Pat. No. 11,136,660.

What is needed is a better way to establish protective coatings containing zinc on nuclear plant components while eliminating many of the difficulties and drawbacks described above.

### Objects and Advantages

Objects of the present invention include the following: providing an improved low temperature deposition method for the wetted surfaces of nuclear power plant cooling system components; providing improved inorganic coatings for stainless steels and nickel alloys; providing a durable zinc oxide coating on stainless steel or nickel alloy components; and providing a method for coating nuclear reactor components without depositing undesirable coatings on the nuclear fuel rods. These and other objects and advantages of the invention will become apparent from consideration of the following specification, read in conjunction with the drawings.

### SUMMARY OF THE INVENTION

According to one aspect of the invention, a method for depositing a divalent metal compound at the surface of a nuclear power plant component comprises:
introducing a treatment solution into the component said treatment solution comprising a source of a divalent metal cation, source of oxygen and a pH control agent;
heating the treatment solution;
allowing the treatment solution to remain in the system for a period of time; and,
draining the solution.

According to another aspect of the invention, a method for maintaining a nuclear power plant system comprises:
shutting down the reactor and allowing the primary system to cool to a selected temperature;
isolating a selected portion of the primary system from the primary system;
exposing the wetted surface area of the selected isolated portion and its components to a treatment solution comprising a source of a divalent metal cation, source of oxygen and a pH control agent;
heating the treatment solution;
allowing the treatment solution to remain in the system for a selected period of time;
draining the solution from the isolated portion of the primary system; and,
removing the means of isolating the selected portion of the primary system and returning the selected portion of the primary system to service.

According to another aspect of the invention, a method for maintaining a nuclear power plant primary system comprises:
shutting down the reactor and allowing the primary system to cool to a selected temperature;
removing a selected primary system component from the primary system;
providing a new replacement component for the selected first primary system component;
exposing the wetted surface area of the new replacement component to a treatment solution comprising a source of a divalent metal cation, a source of oxygen and a pH control agent;
time;
heating the treatment solution to a selected temperature;
allowing the treatment solution to remain in the system for a selected period of time;
draining the solution from the component; and,
installing the new component in place of the first component in the primary system.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a Pourbaix diagram for the Pt—H₂O system.

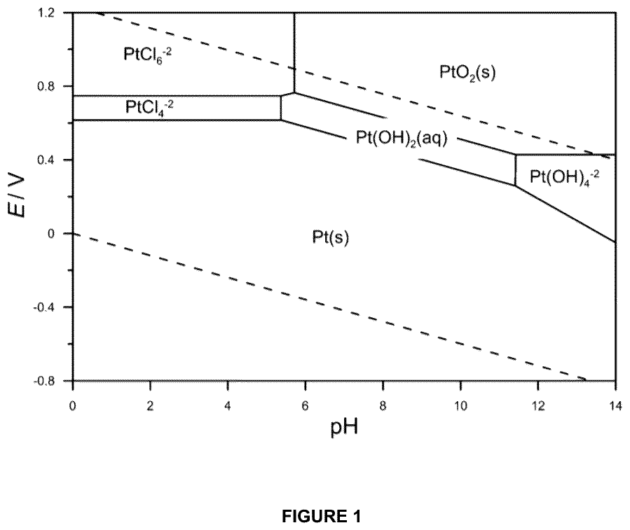

FIG. 2 is a Pourbaix diagram for the Zn—H₂O system.

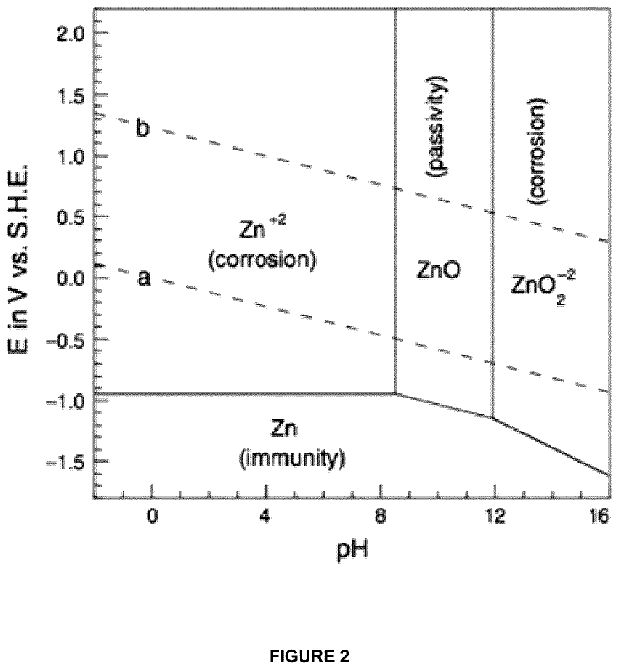

FIG. 3 is a graphical representation of the relative affinities or preferences of some divalent and trivalent metals in passive oxide films.

FIG. 4 is a schematic diagram of a metal oxide deposition process in accordance with some aspects of the invention.

FIG. 5 is a schematic diagram of another metal oxide deposition process in accordance with some aspects of the invention.

FIG. 6 is a schematic diagram of a nuclear power plant cooling system and treatment method in accordance with some aspects of the invention.

FIG. 7 is a photomicrograph in cross section of a ZnO deposit on passivated Type 316L stainless steel.

FIG. 8 presents EDS analysis of as-deposited ZnO layer on Type 316L stainless steel.

FIG. 9 presents EDS analysis of ZnO layer on Type 316L stainless steel after 96 h exposure to simulated BWR water chemistry.

### DETAILED DESCRIPTION OF THE INVENTION

A method is described herein for depositing adherent ZnO or ZnO₂²⁻ (herein collectively referred to as zinc oxide or ZnO) on a nuclear component after chemical decontamination with or without noble metal deposition at low temperature (40 to 100° C.), but potentially at higher temperatures (up to 120° C. if the system is pressurized to about 1 bar (14.5 psi) to prevent boiling using chemicals that are non-corrosive to the RCS components (absence of halogens, lead (Pb) or mineral acids). ZnO may also be deposited on the to-be wetted surfaces of new components at new plants or at existing plants such as replacement SGs on the wetted tube surfaces.

Once deposited and exposed to high temperature, the ZnO has been found to be incorporated in the metal surface or admixed with the existing or newly formed passive layer or CRUD.

One skilled in the art would recognize that is desirable as it would allow for incorporation of both zinc and optionally noble metal for the few months after startup after a plant outage whereafter normal NMCA or zinc addition” may be resumed. Incorporation of zinc before the normal waiting period after a refueling outage with new or “fresh” fuel in the core would have the advantage of reducing worker exposure during future outages. The incorporation of zinc may also reduce the potential for IGSCC of stainless steel after plant startup and operation.

One or more non-limiting examples include taking the power plant out of service, providing the treatment solution containing the divalent metal compound (e.g., a zinc salt) and at least one species as a source of oxygen within a component or portion of the primary system at low temperature, providing the solution with an additive to control pH, allowing the treatment solution to remain in the component at low temperature for a period of time to form an adherent oxide, removing the treatment solution and then returning the plant to operation at high temperature.

The treatment may be performed during a refueling outage at the nuclear power plant.

The treatment may be performed on a component or system prior to installation of that component at a nuclear plant or after a new component is installed at the plant but before high temperature operations commence.

The treatment temperature may be less than 120° C. and more preferably less than 100° C.

The treatment period may be less than 5 days.

The treatment period may be less than 24 hours but more than 30 minutes.

A plant component previously exposed to high temperature operations during power generation mode of the plant may be partially or completely decontaminated with chemical solutions or by mechanical means such as ultrasonic cleaning or water jetting to remove CRUD and passive films leaving behind bare metal, residual passive film or residual CRUD, after which the compound is deposited on these surfaces/materials.

The treatment solution may be applied to a portion of the primary system that is constructed from austenitic stainless steel or nickel-based alloy upon which passive films have formed because of contact with primary coolant during operations or plant commissioning and deposition may occur on the passive film.

The wetted surface of the component or system may have accumulated radioactive CRUD on its surfaces and the treatment creates a deposited film on the CRUD.

The passive film and CRUD may have incorporated radioactive species into their structures rendering them radioactively contaminated and acting as a source of radiation leading to worker exposure. The radioactive species may be Co⁶⁰.

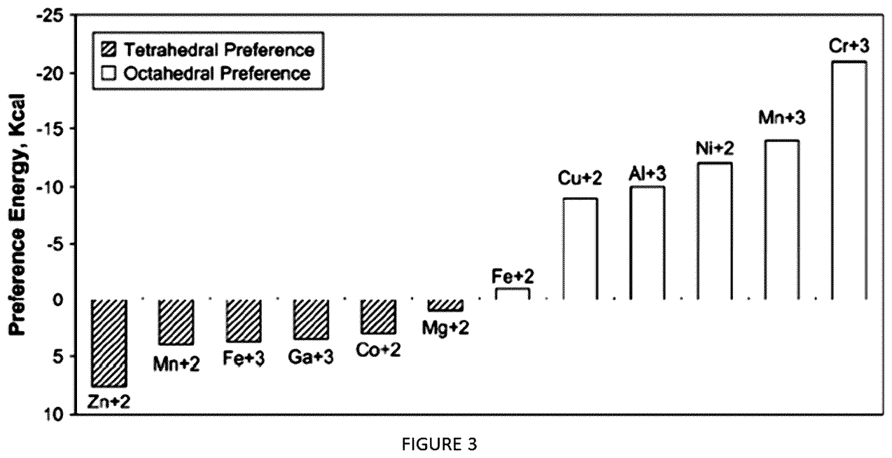

The treatment solution may contain a divalent metal species in the form of a soluble chemical compound. The divalent metal compound may be zinc acetate or zinc nitrate. The zinc compound may be depleted in Zn₆₄. Alternatively, analogous compounds of manganese, a constituent of stainless steels, may be used. Referring to FIG. 3, it can be seen that Mn also has a greater affinity for tetrahedral sites than does Co. Naturally occurring manganese consists entirely of the isotope Mn⁵⁵ which can activate to Mn⁵⁶ by neutron capture but it exhibits a half-life of only 2.578 hours.

The treatment solution may contain a source of oxygen such as water, oxygen, ozone or hydrogen peroxide.

More than one cycle of treatment may performed, producing sequential additive deposition of a compound on the surface including bare metal surfaces of surfaces if passive films or CRUD. Furthermore, two different divalent metal oxides (e.g., Zn and Mn) may be deposited together or in two different deposition cycles, in any desired order and thickness.

The treatment solution may be applied for a period sufficient to deposit at least 0.1 μg/cm² of divalent metal oxide on the surface being treated. The treatment solution may be applied for a period sufficient to deposit at least 10 μg/cm² of divalent metal oxide. The treatment solution may be applied for a period sufficient to deposit at least 100 μg/cm² of divalent metal oxide.

The treatment solution may be drained and stored, and then reused in another system.

The treatment may be conducted in a series of steps to build up a layer of divalent metal species having an affinity for tetrahedral sites in a metal spinel present as a passive film or CRUD to achieve a desired final thickness (μm) or loading (μg/cm²). If two different divalent oxides are deposited in two separate steps, the desired thickness of one oxide might be the same as or different than the desired thickness of the other oxide.

A separate treatment solution may be applied containing a noble metal such as platinum at a concentration of at least 0.5 ppm with no divalent metal species but including a reducing agent, and said treatment may be performed at a temperature less than 100° C.

The noble metal treatment may be applied before the application of the treatment solution containing the divalent metal species such as zinc.

The plant may be returned to service allowing the deposited species to become incorporated into newly formed passive layers after a decontamination of a primary system during operation of the plant at high temperature.

The deposited species may become incorporated into residual passive films or residual CRUD left behind after decontamination after operating of the plant at high temperature.

Illustrative examples of the inventive method for depositing a divalent metal compound are presented below.

### Example

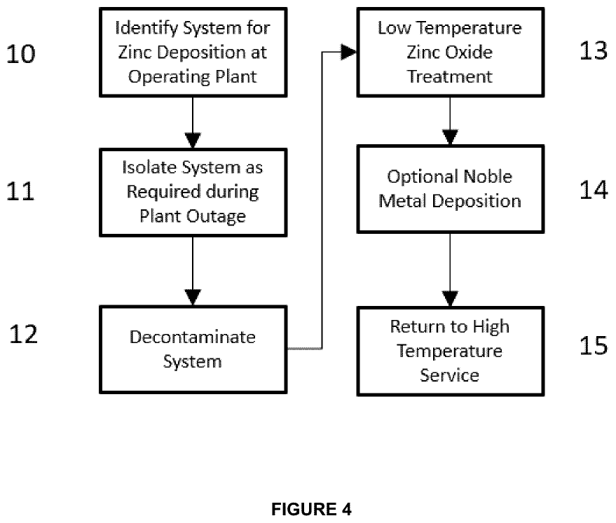

FIG. 4 summarizes one preferred example of a divalent compound (e.g., zinc oxide) deposition process. The method includes identifying, 10, a system with one or more fluidically connected components at an operational nuclear plant where the deposition of zinc at low temperature would be advantageous as described herein. The system may be isolated, 11, to contain zinc deposition reagents during the process. Prior to deposition of the zinc compound the wetted surfaces of the system may be fully or partially decontaminated by chemical or physical means, 12, to remove CRUD or passive layers exposing at least in part bare metal. Low temperature zinc oxide deposition is then performed, 13. This deposition may be performed in one step or multiple steps to build up a deposit of desired thickness and composition. After zinc oxide deposition, a noble metal such as platinum or palladium may be deposited, 14, on the surfaces now covered in whole or in part with zinc oxide. One skilled in the art will recognize the noble metal deposition may be performed before the deposition of zinc oxide. Finally, the system and plant is returned to high temperature operation 15 resulting in the formation of zinc bearing passive film or CRUD as the deposited zinc oxides comingles with or diffuses into the bare metal surfaces, passive layers or residual CRUD, which retards the incorporation of radioactive cobalt species at the surface.

### Example

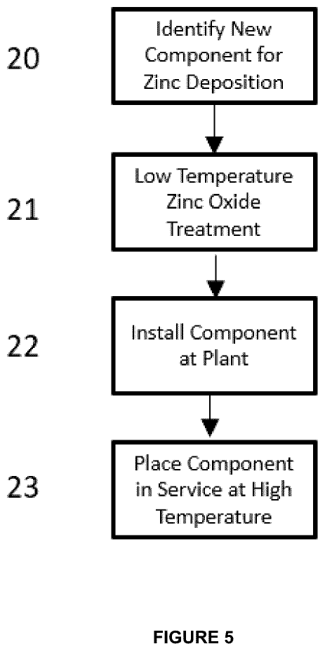

FIG. 5 summarizes another preferred embodiment of a divalent compound (e.g., zinc oxide) deposition process. The method includes identifying a new component, 20, to be used at a nuclear power plant prior to installation at the plant or prior to operation of the plant but after installation if the component is a replacement component. Low temperature zinc oxide deposition is then performed, 21. The component is installed at the plant, 22. The component is then placed in service at high temperature 23 which results in the incorporation of zinc into the newly formed passive layers or CRUD deposits.

### Example

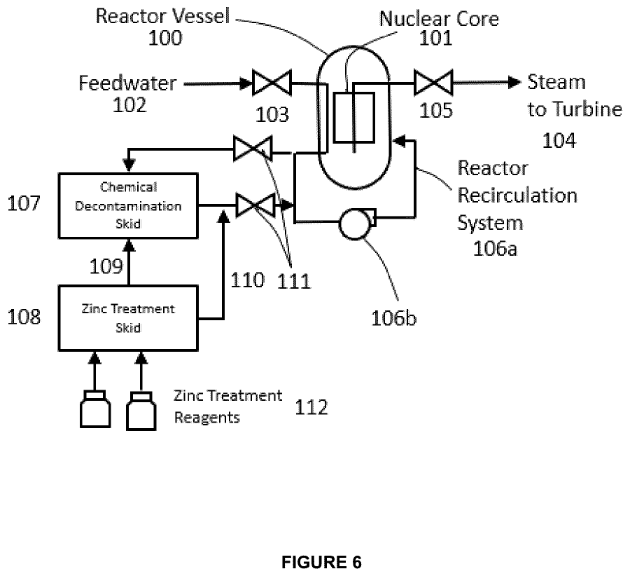

FIG. 6 depicts one example of a system selected for treatment. A nuclear power plant of the boiling water reactor type includes a reactor vessel, 100, a nuclear core, 101, a feedwater system 102 admitting reactor coolant from the RCS via valve 103, and steam supply to a turbine 104 controlled by valve 105. The turbine is in turn connected to an electrical generator, not shown, to produce electricity when the reactor operates at high temperature and elevated pressure. To improve the operation of a BWR plant, a separate reactor coolant recirculation system (RRS) 106a is used to pump fluid from and back to the reactor vessel 100 using one or more pumps 106b. The reactor recirculation system may be configured as one or more recirculation loops. During shutdown for maintenance or refueling, the reactor system is reduced to temperatures below 100° C. and preferably below 40° C. The reactor recirculation system is physically located in areas of the plant where workers can be exposed to radiation emanating from CRUD and passive films on the interior wetted surfaces of the system if these layers contain radioactive cobalt species, as an example. To reduce worker exposure during a maintenance or refueling outage or during futures outages, a chemical decontamination may be performed using a chemical decontamination skid 107 that is temporarily attached to the reactor recirculation system 106a. The flow to and from the skid 107 to the recirculation skid may be isolated by valves 113. One skilled in the art would understand that the decontamination system 107 may contain necessary tanks, piping, valves, pumps, heaters and coolers that allow for mixing, heating, filling, control, cooling and draining of the decontamination solutions. After chemical decontamination, a zinc treatment may be performed at low temperature (e.g., less than 100° C.) using a zinc treatment skid 108 connected directly to the recirculation system 106a using connection 110 or to the chemical decontamination skid via connection 109 which includes the piping, pumps, heaters, and cooling system that may be required to implement the zinc treatment process. Otherwise, these components may be part of the zinc treatment skid 108. Zinc treatment reagents may be prepared ahead of time or mixed in the zinc skid from concentrated chemicals supplied from containers 112.

Additional aspects and exemplary values and variants of the invention are described as follows.

A method for deposition of a compound on the wetted surface of a nuclear plant component in references to FIGS. 4 and 5 is described. The method includes optional deposition of a noble metal on the surface before or after deposition of the compound. The invention may involve the deposition of a zinc oxide compound as ZnO. The zinc is preferably depleted in Zn⁶⁴. Alternatively the deposition may include the deposition of ZnO₂²⁻, or the deposition of a combination of ZnO and ZnO₂²⁻. The exact ratio of ZnO to ZnO₂²⁻ is typically pH dependent. The deposition on the surface is performed from a liquid solution at low temperature, typically up to 120° C., but preferably below 100° C. and more preferably about 90° C.

While the divalent metal oxide may consist of either or both of ZnO and/or ZnO₂²⁻, they are collectively hereinafter referred to simply as zinc oxide.

The zinc oxide may be deposited on bare metal, passive films or CRUD (metallic oxides) which are wetted during plant operation at a nuclear power plant. The bare metal surface may be a surface that has been decontaminated at an operating nuclear power plant (see FIG. 4) or the surface of a new or replacement component (see FIG. 5). After deposition, the nuclear plant components selected for treatment with the deposition process are returned to, or in the case of a new or replacement component placed in service, at high temperature, typically 260° C. to 275° C. at a BWR or at about 300° C. at a PWR. Exposure to high temperature reactor coolant after low temperature deposition incorporates the zinc into tetrahedral sites in newly formed or existing passive film surface spinels or CRUD. Such incorporation mitigates the incorporation of radioactive cobalt species into the passive films or CRUD, and may help mitigate IGSCC.

As shown in FIG. 6, the zinc treatment system or equipment may be integral to or separate from a chemical decontamination system. The zinc treatment chemicals may be supplied as concentrated reagents and mixed with water during injection or after the injection into the system. The reagent chemicals are prepared at room (ambient) temperature, typically 20-40° C. At these cold temperatures the solutions or concentrates are stable; in other words, no precipitation or deposition of zinc oxide occurs on surfaces or in the bulk solutions.

For a new or replacement component to be installed at or placed in service at a plant, a process like that shown in FIG. 5 is followed.

The solutions or concentrates may be heated to the application temperature of say, 90° C., before injection, after injection, or during injection using heating systems quite commonly used for chemical cleaning or decontamination, including electrical heaters or steam heating. The treatment time once the desired temperature has been reached may be less than 10 minutes, less than 1 hour, less than 4 hours, less than 24 hours or up to 5 days (120 hours).

The zinc oxide deposition reagents in the treatment solution consist of (1) a zinc salt, (2) a pH control agent, (3) and a source of oxygen. The zinc salt can be zinc acetate or zinc nitrate. Other zinc salts that could be used are zinc chloride and zinc citrate. Other anion reagents that complex with zinc may be added in addition to the zinc salt to stabilize the solution such as tartrates. Analogous reagents may be used for the deposition of manganese oxides.

The pH control agent used to raise pH and promote deposition and stabilize the treatment solution are ammonia, ammonium hydroxide, ethylenediamine (EDA), triethanolamine (TEA), sodium hydroxide or potassium hydroxide. As seen in the previously described Pourbaix diagram from the zinc-water system, zinc oxides are stable solid phases at pH>8, and more favorably at pH>11. For the zinc oxide process described herein, the pH is greater than 8, preferably greater than 11 and most preferably >12.

According to various examples, the concentration of zinc salt (e.g., zinc acetate where the zinc is preferably depleted in Zn-64) in the treatment solution is at least (1) 1×10⁻⁷, 1×10⁻⁶, 1×10⁻⁵ moles/liter (M) as zinc, (2) less than 1×10⁻³, 1×10⁻⁴, 1×10⁻⁵ and 1×10⁻⁶ moles per liter (M) as zinc and or (3) any zinc concentration between any two such values (e.g., between 1×10⁻⁷ and 1×10⁻³ moles per liter zinc such as between 1×10⁻⁶ and 1×10⁻⁴ moles per liter (M)). The equivalent concentration of a 1×10⁻⁴ M zinc solution is about 6.5 ppm. The equivalent concentration of a 1×10⁻³ M zinc solution is about 65 ppm. At such concentration ranges it has been found that deposits of zinc oxides from 0.1 to 10 μg/cm² can be achieved in about 4 hours at 90° C., where the deposition thickness occurs linearly over time so thinner films may be achieved with shorter contact time and thicker films with greater treatment time. These specific surface coverages correspond to 0.1 to about 2% of a 600 μg/cm² passive film. The treatment solution can be drained before it is depleted in available zinc.

According to various examples, the zinc oxide may be deposited in multiple steps by draining the solution between steps, replenishing it, or supplying a fresh solution of the same or different zinc concentration. In the same way, zinc oxide and manganese oxide may be deposited in alternate steps.

The specific molarity or concentration chosen depends on the surface to volume ratio of the system. For example the surface to volume ratio of a 12 inch diameter Schedule 80 stainless steel pipe is 138 cm²/liter of solution on the interior The surface to volume ratio of a 4 inch Schedule 80 stainless steel pipe is 411 cm²/liter Hence, one skilled in the art would see that a 4 inch pipe may require up to 4 times the concentration of zinc reagent as a 12 inch pipe (411/138≈3) to achieve the same thickness of zinc oxide on the surface if the process is applied until zinc is depleted from the treatment solution.

According to various examples, the source of oxygen may be oxygen, ozone, water or hydrogen peroxide. The concentration of hydrogen peroxide in the treatment solution is at least (1) 0.01, 0.1. 0.2, 0.5, 1 percent by weight, (2) less than 2, 1 and 0.5 percent by weight and or (3) any peroxide concentration between any two such values (e.g., between 0.01 and 2 percent by weight such as between 0.1 and 1 percent by weight).

According to various examples, the pH is above pH 8, preferably above pH 11 and most preferably above pH 12. The pH is achieved by addition of a base such as ammonium hydroxide, potassium hydroxide, sodium hydroxide, EDA or TEA.

The treatment solution may contain other complexing agents such as a tartrate or a citrate to stabilize the solution.

Noble metal deposition may be performed before or after zinc compound deposition, or between zinc compound deposition steps. For example, deposition of platinum metal with a surface coverage of 0.1 to 1 μg/cm² which would correspond to about 1% of the passive film on a wetted surface at a nuclear plant, can be achieved from a solution containing 0.2 to 15 ppm and most preferably 0.5 ppm (parts per million or nearly equivalently mg/kg) sodium hexaplatinate at up to 90° C. with or without a reducing agent such as hydrazine at 1 to 1000 ppm, and most preferably about 60 ppm hydrazine when used.

Exemplary experimental results.

### Example

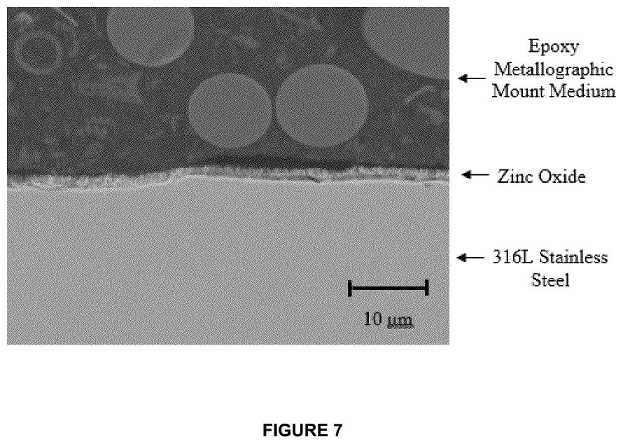

FIG. 7 shows a polished metallographic cross-section of a zinc oxide deposited on a passivated 316L austenitic stainless steel test coupon. The zinc oxide layer is about 1 μm thick, uniform and highly adherent. The coupon was pre-passivated in a 10% citric acid solution at 90° C. in four hours, a technique commonly used to accelerate passivate stainless steel parts and components. Other depositions were performed on clean bare and polished stainless-steel coupons and on metallic oxides as would occur on CRUD.

The treatment solution for this experiment contained a zinc salt at about 1×10⁻⁴ M, ammonium hydroxide to raise pH>11, and less than 1% hydrogen peroxide. The treatment temperature was 90° C. Thinner deposits as thin as 0.01 μm were also achieved with less uniform surface coverage but still exhibiting excellent adhesion.

### Example

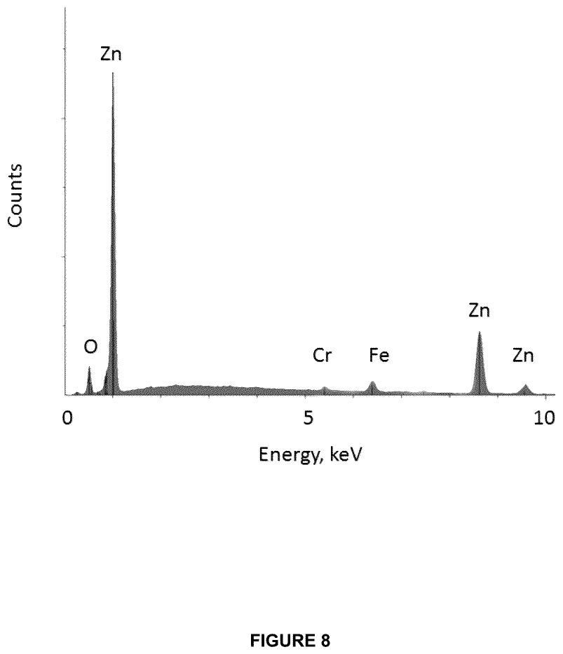

FIG. 8 is an energy dispersive spectroscopy (EDS) result of the surface of the as deposited film in FIG. 7. The depth of penetration of the x-rays in the EDS technique is about 1 to 2 μm. The presence of zinc is clear.

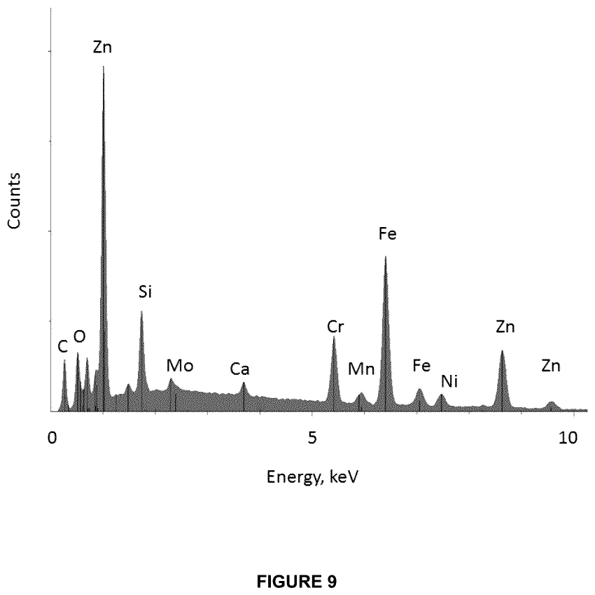

FIG. 9 is an EDS plot of a zinc oxide deposit that was subjected to 96 hours of treatment in simulated BWR reactor coolant at 290° C. The presence of iron, chromium, and nickel (from 316L coupon) as well as zinc to the admixing and incorporation of the zinc into the coupon surface. The treatment in the simulated BWR coolant resulted in no measurable change in the coupon or deposit mass further demonstrating the excellent adherence of the deposit.

1. A method for treating a water-contacting surface of a nuclear power plant component, comprising the steps of:
a) selecting a component to be treated;
b) introducing an aqueous treatment solution into contact with the water contacting surface of said component, said treatment solution comprising:
a source of divalent metal cations,
a source of oxygen, and,
a pH controlling agent;
c) heating said treatment solution to a selected temperature;
d) maintaining said treatment solution in contact with said water contacting surface for a selected time; and,
e) draining said treatment solution from said component.

2. The method of claim 1 wherein said component comprises a material selected from the group consisting of: wrought austenitic Type 316 and 304 stainless steels including their low carbon varieties; nickel-based Alloy 600 or Alloy 690; weld metals including Type 309, Alloy 182, Alloy 82, Alloy 152, Alloy 52; and cast stainless steel materials CF3, CF3M, CF8, CF8M.

3. The method of claim 1 wherein said divalent metal cation is selected from the group consisting of: Zn²⁺ and Mn²⁺.

4. The method of claim 3 wherein said divalent metal cation comprises Zn and said Zn is depleted in Zn⁶⁴.

5. The method of claim 1 wherein said source of divalent metal cations comprises a soluble salt selected from the group consisting of: metal acetates and metal nitrates.

6. The method of claim 1 wherein said source of oxygen comprises a species selected from the group consisting of: water; oxygen; ozone; and hydrogen peroxide.

7. The method of claim 1 wherein said pH controlling agent comprises a compound selected from the group consisting of: ammonia; ammonium hydroxide; ethylenediamine (EDA); triethanolamine (TEA); sodium hydroxide; and potassium hydroxide.

8. The method of claim 7 wherein said pH controlling agent is added in an amount sufficient to maintain said treatment solution in the range of pH>8.

9. The method of claim 1 wherein said selected temperature is 120° C. or less, and said selected time ranges from 10 minutes to 120 hours.

10. The method of claim 1 further comprising the step of:
f) depositing a noble metal on said water contacting surface.

11. The method of claim 10 wherein said noble metal comprises Pt and said deposition uses an aqueous solution of 0.2 to 15 ppm sodium hexaplatinate and 1 to 1000 ppm hydrazine, maintained at a temperature of 90° C. or less.

12. The method of claim 1 wherein said selected component is a new component to be treated prior to installation.

13. The method of claim 1 wherein said selected component is an existing component that has been removed from high temperature service to be treated at low temperature, after which it will be returned to high temperature service.

14. The method of claim 1 further comprising the step of:
g) providing a skid-mounted treatment unit comprising fluid handling systems, fluid heating and cooling systems, and valves, wherein said treatment unit is connected to a portion of the primary system of said nuclear power plant.

15. The method of claim 1 further comprising the step of:
h) decontaminating said water contacting surface of said selected component prior to treating said surface.

16. The method of claim 15 wherein said decontaminating step comprises mechanical cleaning by a process selected from the group consisting of: water jet cleaning and ultrasonic cleaning.

17. The method of claim 15 wherein said decontaminating step comprises chemical cleaning by exposure at a selected temperature between ambient and 120° C. to complexing/chelating solutions selected from the group consisting of: oxalic acid; citric acid; nitric acid; ethylendiamine tetra acetic acid (EDTA); oxidizing agents; and reducing agents.

18. The method of claim 1 wherein:
steps b) through e) are carried out using a source of a first divalent metal cation to deposit a first metal oxide film of a first selected thickness; and,
steps b) through e) are carried out using a source of a second divalent metal cation to deposit a second metal oxide film of a second selected thickness.

19. The method of claim 18 wherein said first and second divalent metal cations are selected from the group consisting of: natural Zn²⁺; depleted Zn²⁺; and natural Mn²⁺.
